(19) United States
(12) Patent Application Publication
(10) Pub. No.: US 2026/0194955 A1
(43) Pub. Date: Jul. 9, 2026

(54) METHOD AND APPARATUS FOR LIMITING RE-RUSH CURRENT IN A POWER SUPPLY UNIT (PSU) USING A BATTERY BACKUP UNIT (BBU)

(71) Applicant: Microchip Technology Incorporated, Chandler, AZ (US)

(72) Inventor: Jongwan Kim, Cedar Park, TX (US)

(21) Appl. No.: 19/440,298

(22) Filed: Jan. 5, 2026

Related U.S. Application Data
(60) Provisional application No. 63/742,314, filed on Jan. 6, 2025.

(51) Int. Cl. G06F 1/30; H02J 9/06; H02M 1/42; H02M 3/335

(52) U.S. Cl. CPC G06F 1/305; H02J 9/061; H02M 1/4283; H02M 3/33584

(57) ABSTRACT

Disclosed herein are apparatus, system, method, and computer-readable medium aspects for limiting re-rush current in a power supply system. An example method may include detecting an AC power dropout event, activating a battery backup unit (BBU) to supply energy, charging a bulk capacitor of a power factor correction stage within a power supply unit during the AC power dropout event using energy stored in the BBU, and resuming power conversion in the power supply system in response to restoration of AC power with limited or no re-rush current.

### CROSS-REFERENCE TO RELATED APPLICATION

The present application claims priority from U.S. Provisional Patent Application No. 63/742,314 filed on Jan. 6, 2025, which is incorporated herein by reference in its entirety.

### TECHNICAL FIELD

The present disclosure relates generally to power supply systems, and more specifically to systems and methods for controlling and mitigating re-rush current in power supply units (PSUs) and battery backup unit (BBU)-integrated systems.

### SUMMARY

According to an aspect of one or more examples, there is provided a method for limiting re-rush current in a power supply system. The method may include detecting an AC power dropout event, activating a battery backup unit (BBU) to supply energy, charging a bulk capacitor of a power factor correction (PFC) stage within a power supply unit (PSU) during the AC power dropout event using energy stored in the BBU, and resuming power conversion in the power supply system in response to restoration of AC power with limited or no re-rush current. The BBU may simultaneously supply power to a load while charging the bulk capacitor, which may occur at an output of the PFC stage. Charging the bulk capacitor may occur through a controlled discharge process of the BBU. The method may also include monitoring the voltage of the PFC bulk capacitor to determine when it is fully charged. The BBU may prioritize supplying power to a load in response to the bulk capacitor being fully charged. The BBU may be activated in response to a PSU output falling below a threshold voltage and may be turned off in response to the PSU output exceeding the threshold voltage. The method may also include detecting restoration of AC power and transitioning the power supply system to steady-state operation. Power conversion may resume in response to detecting restoration of AC power. A bus voltage may exceed a peak AC input voltage when AC power is restored. A voltage rating of the bulk capacitor may be approximately 400V_{dc} or 450V_{dc} for a 277V_{ac} input voltage, however other voltage ratings such as 800 V_{dc} may be used, for example.

According to an aspect of one or more examples, there is provided an apparatus for limiting re-rush current in a power supply system. The apparatus may include a power supply unit (PSU) having a power factor correction (PFC) stage with a bulk capacitor, a battery backup unit (BBU) to store and discharge energy, and a controller to detect an AC power dropout event, activate the BBU to charge the bulk capacitor during the AC power dropout event, and resume power conversion in the PSU in response to restoration of AC power without re-rush current. The BBU may simultaneously supply power to a load while charging the bulk capacitor. The controller may monitor the voltage of the bulk capacitor to terminate charging when the capacitor is fully charged. The PSU and the BBU may be connected via a bus line and a return line. The BBU may include a battery pack and a bi-directional DC-DC converter. The controller may detect AC power restoration and transition to a steady-state operating mode. A voltage rating of the bulk capacitor may be approximately 400V_{dc} or 450V_{dc} for a 277V_{ac} input voltage, however other voltage ratings such as 800 V_{dc} may be used, for example. The apparatus may also include a detection module for determining AC power dropout and restoration conditions. The controller may activate the BBU based on a predefined voltage threshold for the bulk capacitor. The voltage of the bulk capacitor may be incrementally increased during a pre-charging state to avoid or limit re-rush current.

### BRIEF DESCRIPTION OF DRAWINGS

FIG. 1 shows a circuit diagram of a server rack system that integrates power supply units (PSUs) and battery backup units (BBUs) according to the prior art.

FIGS. 2A-2E show a power flow diagram of a server rack system according to the prior art.

FIGS. 3A-3E show a power flow diagram of a server rack system according to one or more examples.

FIG. 4 is a flowchart of a method for preventing re-rush current in a power supply system, according to some aspects of the present disclosure.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Modern data centers rely on uninterrupted and reliable power delivery to maintain continuous operation of server racks. These server racks often integrate power supply units (PSUs) and battery backup units (BBUs) to ensure power delivery during both normal and failure scenarios. In particular, BBUs often provide power for a limited duration (e.g., up to 4 minutes) when the AC input power fails. This transition process introduces complex power management challenges. Although data centers are used herein as one example of an application that experiences these challenges, the present application is not limited to data centers, and applies to other applications that use PSUs, BBUs, or other types of power supplies to provide consistent power delivery.

When AC power resumes, the PSU attempts to recharge the PFC (power factor correction) bulk capacitor. If the AC input voltage exceeds the DC bus voltage at that time, an uncontrolled re-rush current can occur. This high peak current places undue voltage and current stresses on the power devices within the system, which can reduce reliability, lifespan, and efficiency.

Existing solutions primarily focus on suppressing re-rush current through PSU-level control mechanisms. While such approaches may alleviate the symptoms to some extent, they fail to address the root cause of re-rush current at a system-wide level. For high-power PSUs exceeding 5 kW, these challenges become increasingly difficult to manage, given the higher energy demands and stresses involved. Therefore, there exists a need for a solution that eliminates the root cause of re-rush current, rather than merely controlling or suppressing it.

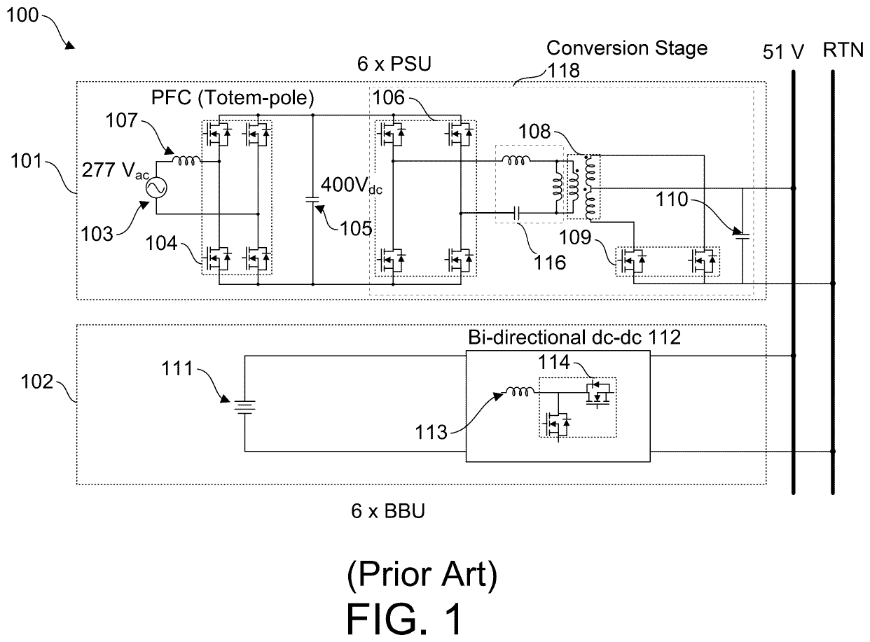

FIG. 1 shows a circuit diagram of a server rack system 100 that integrates power supply units (PSUs) and battery backups (BBUs) according to the prior art. The system 100 may provide uninterrupted operation, but faces challenges when AC power is restored, particularly due to the occurrence of re-rush current during the recovery phase. As shown in FIG. 1, the system 100 may include one or more power supply units (PSUs) 101 (e.g., 6×PSU) and one or more battery backup units (BBUs) 102 (e.g., 6×BBU).

The PSU 101 may convert the AC input voltage into regulated DC voltage for the load and may include mechanisms to charge a DC link capacitor and improve power quality. The AC voltage source 103 may be the main AC input power that supplies energy to the PSU 101. The AC voltage source 103 may come from an external source, such as the utility grid, and may operate at a standard line voltage (e.g., 277V_{ac}) depending on the region. The AC voltage source 103 may provide the power that will undergo rectification and conversion into DC power through subsequent stages in the PSU 101.

The switching transistors 104 coupled to the AC voltage source 103 may represent the active power factor correction (PFC) stage using a totem-pole topology. The switching transistors 104 may be, without limitation, metal-oxide-semiconductor field-effect transistors (MOSFETs) or advanced switches like GaN transistors for higher efficiency and switching speeds. The switching transistors 104 may operate in a high-frequency switching mode to shape the input current waveform to follow the AC input voltage waveform. This may improve the power factor of the system 100, minimizing reactive power losses and meeting regulatory requirements for power quality. The totem-pole topology may replace the traditional diode bridge rectifier, reducing conduction losses.

The capacitor (e.g., 400V_{dc}) 105 may be the DC link capacitor, or alternatively, the bulk capacitor. The capacitor 105 may smooth and store rectified DC voltage output from the PFC stage. The capacitor 105 may stabilize the DC bus voltage at approximately 400V_{dc} and can go up to 450V_{dc}, which may be a typical intermediate DC voltage level in high-power PSUs. This voltage may be used as an input for the downstream DC-DC conversion stage 118.

Conversion stage 118 can be an LLC resonant converter. In these embodiments, conversion stage 118 can include switching transistors 106, a resonant tank 116 including a resonant capacitor and two inductors (e.g., a resonant inductor and a magnetizing inductor), a center-tapped isolation transformer 108, and a rectifier including switching transistors 109 and capacitor 110, as further explained below. In one or more examples, conversion stage 118 can be any other bidirectional DC-DC topology, such as a phase-shifted full bridge converter, a CLLLC converter, or other converter topologies as would be understood by a person of ordinary skill in the art.

The switching transistors 106 to the right of the bulk capacitor 105 may be part of the DC-DC conversion stage 118. The switching transistors 106 may be high-frequency MOSFETs. The switching transistors 106 may switch at high frequencies (e.g., 50 kHz to 500 kHz) to drive a transformer or inductor for voltage conversion. The switching transistors 106 may regulate the transfer of energy from the 400V_{dc} DC bus to the lower DC output voltage levels for the load.

The inductor 107 at the left side of the PFC may be part of the boost converter circuit within the PFC totem-pole topology. The inductor 107 may store energy during the on-time of the switching transistors 104 and release energy during the off-time, boosting the AC input voltage (e.g., 277V_{ac}) to the DC link voltage (e.g., 400V_{dc}). The inductor 107 may help regulate and smooth the current waveform to maintain proper power factor correction.

The center-tapped isolation transformer 108 in the middle of the system 100 may represent an isolation transformer used for voltage conversion and isolation in the DC-DC conversion stage 118. The center-tapped isolation transformer 108 may transfer energy between the primary side (400V_{dc} input) and the secondary side (lower voltage output, such as 51V). The center-tapped isolation transformer 108 may provide galvanic isolation, ensuring electrical separation between the input power source and the output load. The turns ratio of the center-tapped isolation transformer 108 may determine the step-down voltage conversion.

The switching transistors 109 and capacitor 110 on the right side of the system 100 may represent the secondary-side rectification and filtering stage of the DC-DC conversion stage 118. The switching transistors 109 may be synchronous rectifiers (typically MOSFETs) that may replace diodes to improve efficiency by reducing forward voltage drops. The switching transistors 109 may rectify the high-frequency AC signal from the center-tapped isolation transformer 108 into a DC voltage. The capacitor 110 may smooth the rectified voltage, delivering a stable and regulated DC output to the load.

The 51V line may be the positive DC output voltage generated by the PSU 101. The 51V line may be used to power the load (e.g., servers, storage devices, without limitation) in a data center, though other applications are possible as well. The 51V level may be a standard output voltage, slightly higher than the nominal 48V DC, to account for transmission losses and voltage regulation. The RTN line (Return) may be the return path for the 51V DC output current. The RTN line may complete the electrical circuit, acting as the negative rail or reference voltage for the load.

The BBU 102 may provide backup power to the system 100 when the AC input fails. The voltage source on the left of the BBU 102 circuit may represent a battery pack 111. The battery pack 111 may provide backup DC power to the system 100 during AC power failure. The battery pack 111 may be made of lithium-ion cells or other energy-dense chemistries to ensure high reliability, long life, and sufficient backup capacity. The battery voltage (e.g., 12V) may be lower than the system DC bus voltage (51V) and may receive a voltage boost during discharge.

The bi-directional DC-DC converter 112 at the core of the BBU 102 circuit may enable energy flow in both directions. During battery discharge, the converter 112 may boost battery voltage to match the 51V DC bus to supply the load. During charging, the converter 112 may step down the 51V DC bus voltage to recharge the battery pack 111. The converter 112 may include an inductor 113 and two switching transistors 114. The inductor 113 located in the bi-directional DC-DC converter 112 may act as an energy storage element during both boost (discharge) and buck (charge) operations. During battery discharge (boost mode), the inductor 113 may store energy when the switching transistors 114 turn on and release energy to the output when the switching transistors 114 turns off. During charging (buck mode), the inductor 113 may regulate current flow into the battery 111 to ensure proper charging profiles. The two switching transistors 114 (typically MOSFETs) may control energy flow in the bi-directional DC-DC converter 112. The switching transistors 114 may operate in high-frequency switching mode to enable high power density. During battery discharge (boost mode), the switching transistors 114 may alternate switching to step up the battery voltage to the system bus voltage (51V). The inductor's 113 energy release may support voltage boosting. During charging (buck mode), the switching transistors 114 may step down the 51V DC bus voltage to a lower voltage suitable for charging the battery 111. Although not explicitly shown in FIG. 1, the converter 112 may operate under control logic that determines when to enter boost mode to supply power to the DC bus, when to enter buck mode to recharge the battery 111 when AC power is restored, and current and voltage regulation to protect the battery 111 and ensure efficient operation.

The 51V line may be the positive DC bus voltage shared between the PSU 101 and the BBU 102 circuits. When the AC power fails, the bi-directional DC-DC converter 112 may boost the battery voltage to match the 51V line, ensuring continuous power delivery to the load. During charging, the 51V line may provide power to recharge the battery 111. The RTN line (Return) may serve as the return path for the current flowing from the 51V line through the load and back to the power source (BBU or PSU). The RTN line may act as the negative rail in the system's 100 DC power delivery architecture.

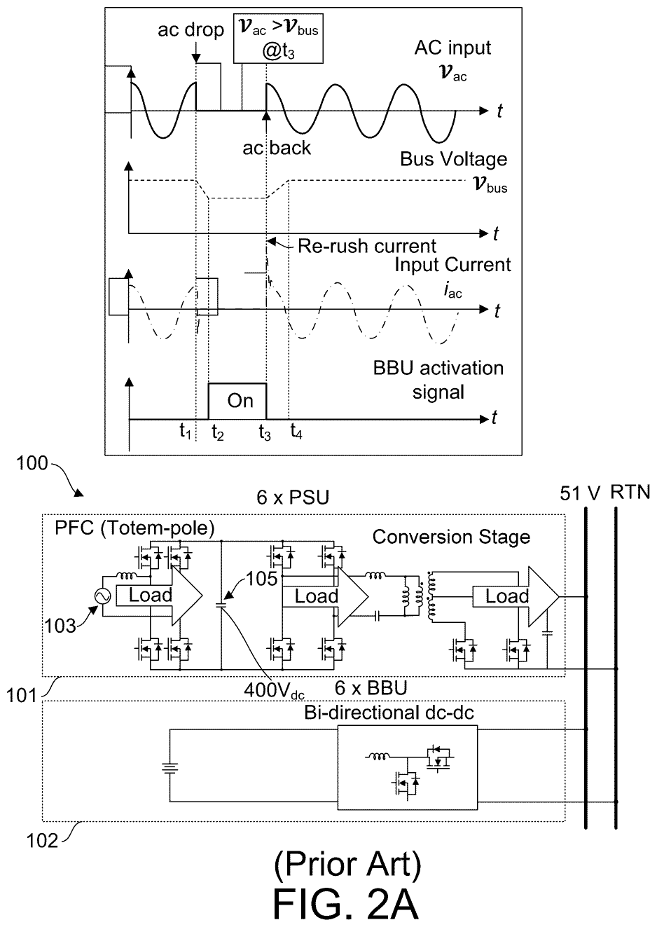

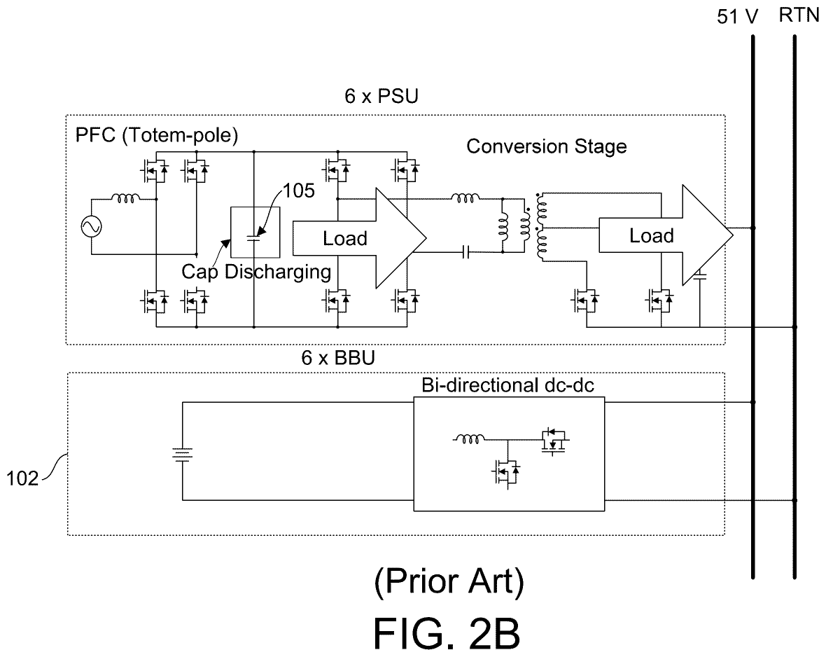

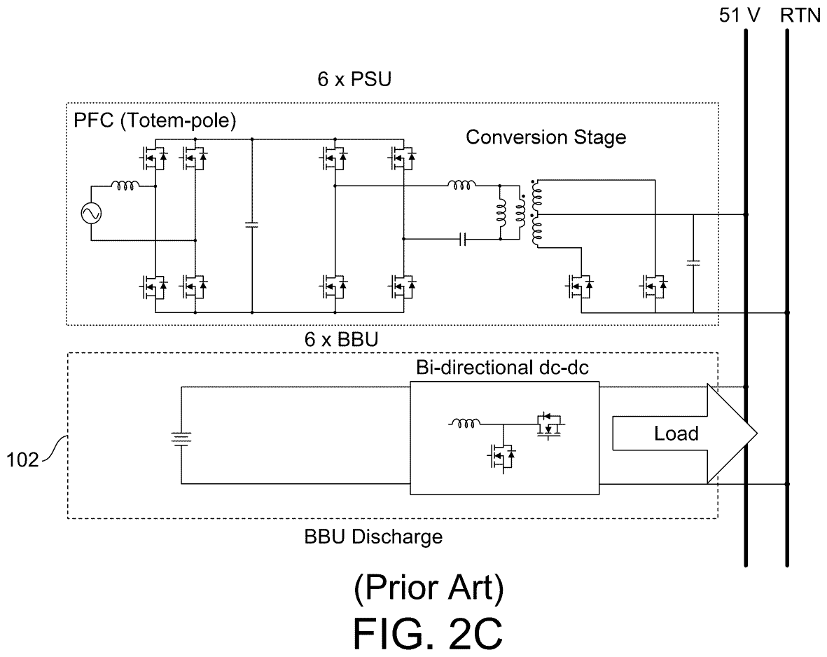

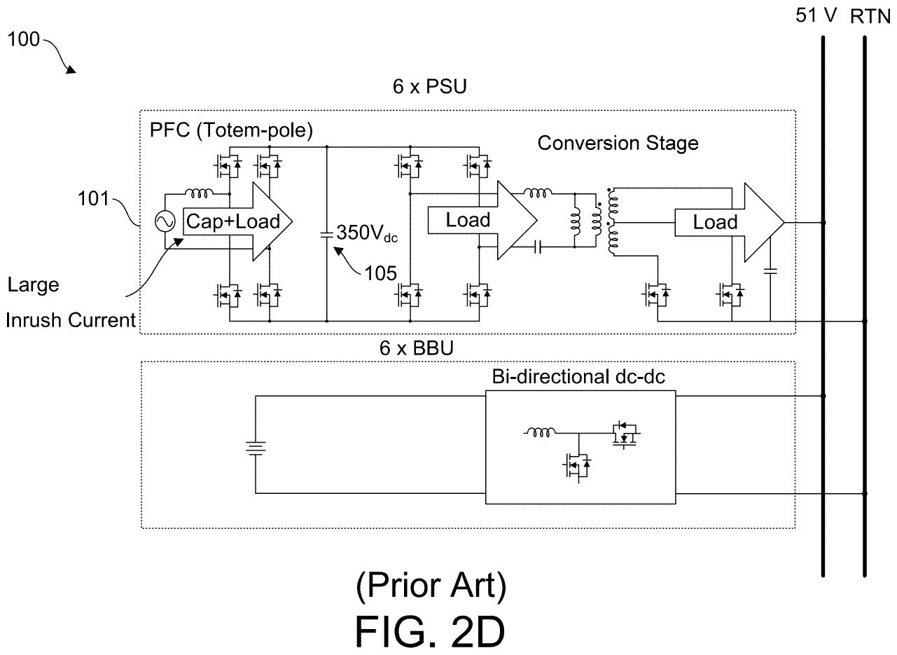

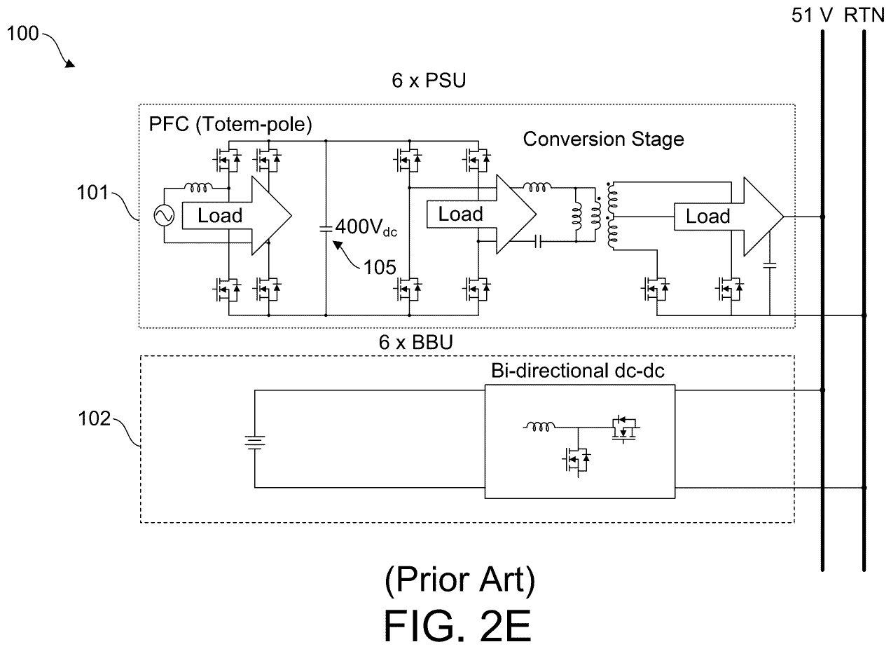

FIGS. 2A-2E show a power flow diagram of the server rack system 100 according to the prior art. Referring to FIGS. 2A-2E, the power flow within the system 100 can be divided into five phases as follows. During a steady state phase (t<t₁) as shown in FIG. 2A, before any disturbance, the AC voltage source 103 may provide continuous energy to the PSU 101, which in turn may deliver power to the server load. During this phase, the power factor correction (PFC) bulk capacitor 105 may be fully charged, maintaining a stable DC voltage bus. The BBU 102 may remain inactive, as backup power may not be utilized. This may be the normal operational state of the system 100.

During a capacitor discharging phase (t₁<t<t₂) as shown in FIG. 2B, at time t₁, the AC input power may fail. In response, the energy stored in the bulk capacitor 105 may begin discharging to sustain power delivery to the load. This phase may be transient and may last only until the BBU 102 activates.

During a BBU discharging phase (t₂<t<t₃) as shown in FIG. 2C, at time t₂, the BBU 102 may be activated to take over power delivery to the server rack load. The activation may occur within approximately 2 milliseconds after detecting the AC input failure. During this phase, the BBU 102 may discharge its stored energy to maintain uninterrupted operation of the server load. The BBU 102 may remain active and sustain power delivery for a limited duration, typically up to 4 minutes depending on battery capacity.

During a recovery state phase (t₃<t<t₄) as shown in FIG. 2D, at time t₃, the AC input power may be restored, and the PSU 101 may resume operation. During this phase, the PSU 101 may begin to recharge the bulk capacitor 105. If the AC input voltage (v_{ac}) exceeds the DC bus voltage (v_{bus}) at this moment t₃, a large inrush current, or re-rush current, may be introduced. The re-rush current may arise due to the large voltage difference between the AC input and the discharged state of the capacitor 105. This phase exposes several drawbacks in the system 100, including excessive peak current stress, component degradation, thermal stress, and system instability.

During a steady-state phase (t>t₄) as shown in FIG. 2E, at time t₄, the bulk capacitor 105 may be fully charged, and the PSU 101 may resume stable power delivery to the server load. The BBU 102 may disengage, and the system 100 may return to its normal operational state. While the system 100 may stabilize at this point, the stresses and potential component degradation introduced during the recovery phase may have already compromised system reliability.

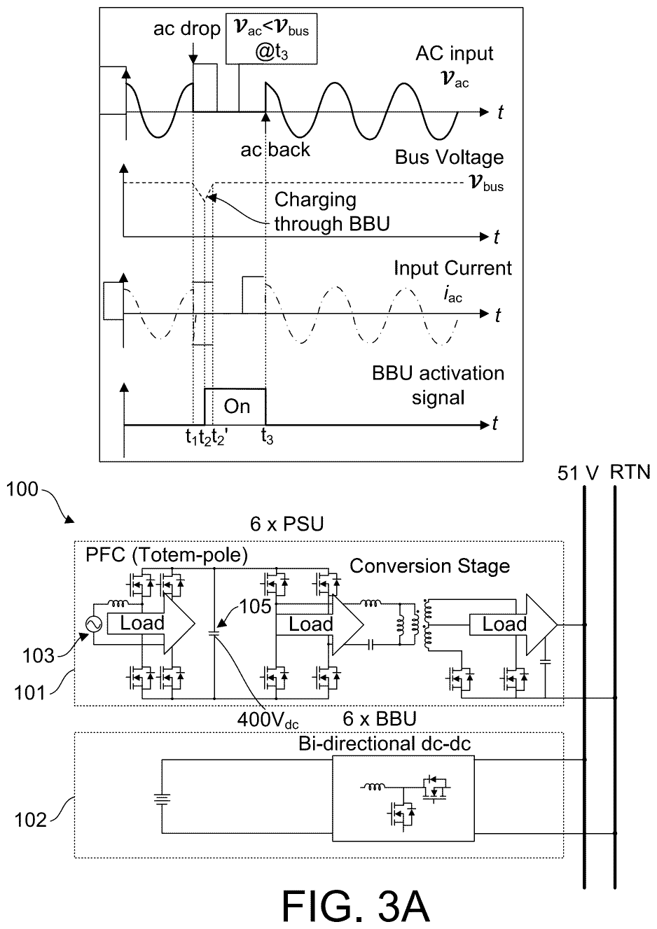

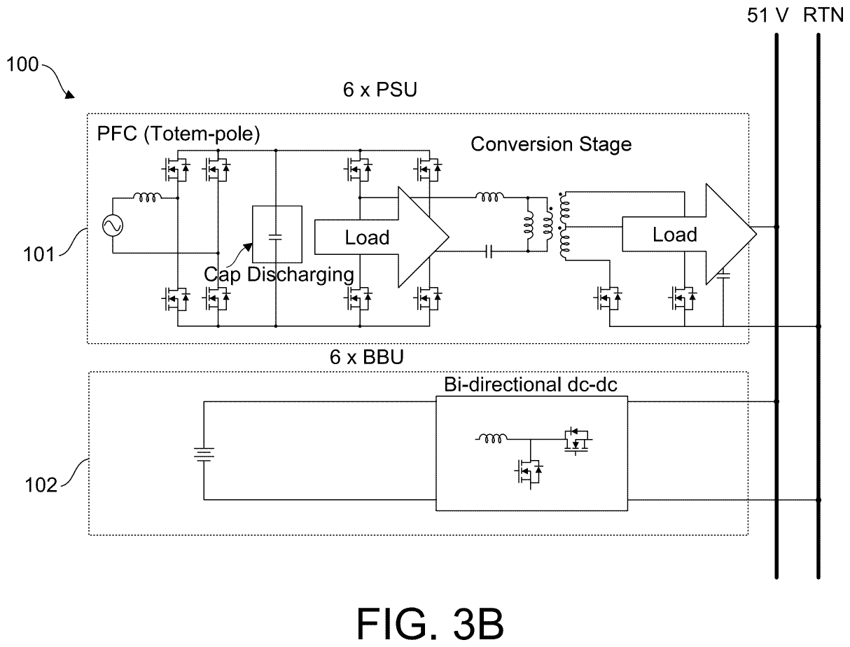

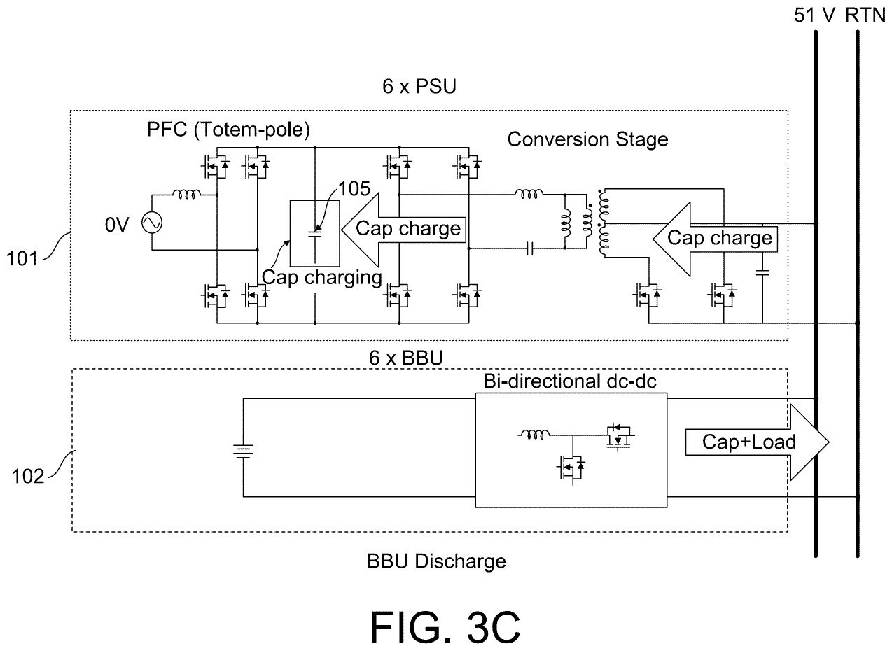

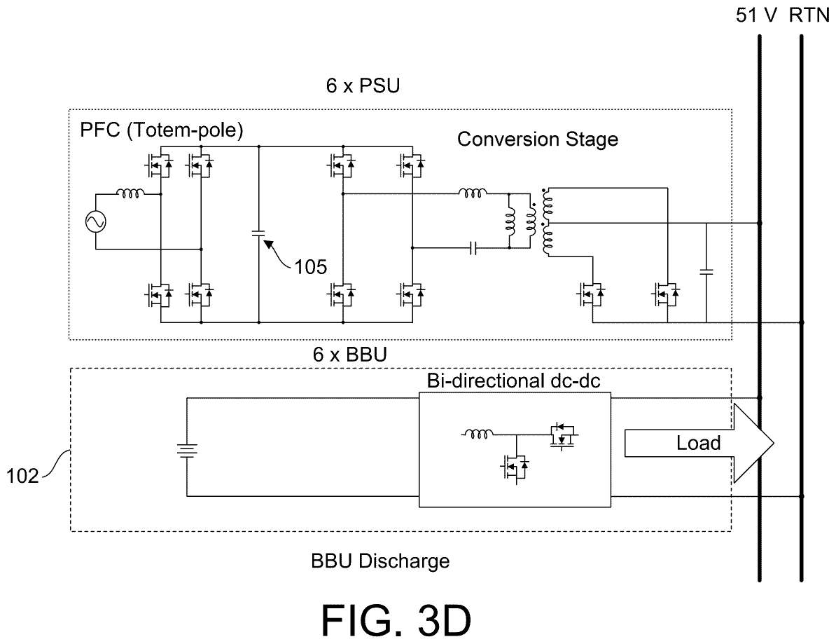

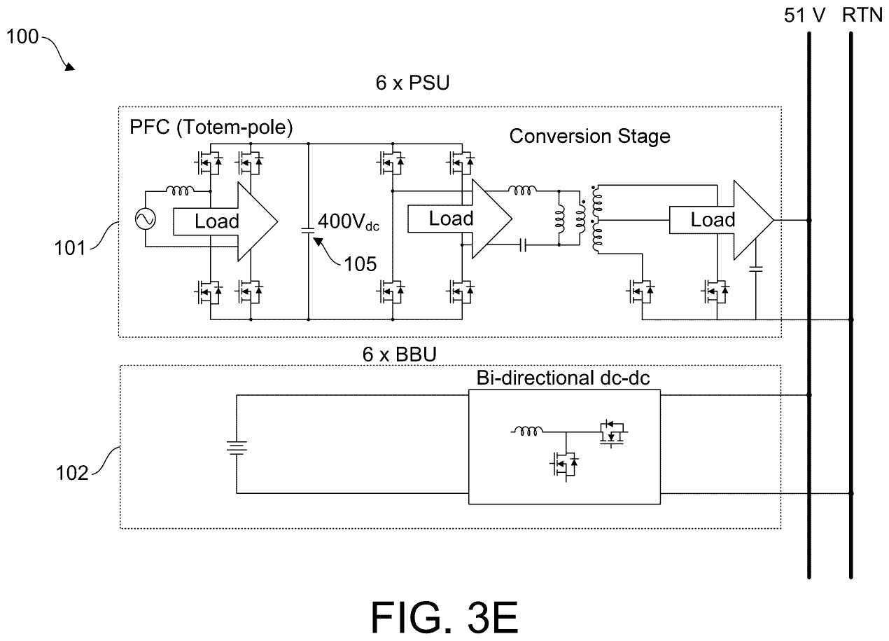

FIGS. 3A-3E show a power flow diagram of the server rack system 100 according to one or more examples. Referring to FIGS. 3A-3E, the power flow within the system 100 can be divided into five phases as follows.

During a steady-state phase (t<t₁) as shown in FIG. 3A, the PSU 101 and BBU 102 may behave as they do in FIG. 2A during the system's 100 normal operational state, or steady-state operation. The AC voltage source 103 may supply energy to the PSU 101. The power factor correction (PFC) stage may ensure proper input power conditioning. The bulk capacitor 105 may maintain its voltage at a nominal operating level. The BBU 102 may remain idle or in standby mode, ready for activation if an AC dropout occurs. Power may flow continuously from the AC voltage source 103 to the load without interruption.

During a capacitor discharging phase (t₁<t<t₂) as shown in FIG. 3B, at time t₂, an AC power dropout may be detected. This can occur due to power interruptions, brownouts, or grid instability. The AC input voltage may drop, triggering a system response. The PSU 101 may detect the dropout and prepare to enter a pre-charging state. The BBU activation signal may be generated, and the BBU 102 may be engaged to compensate for the loss of AC input voltage. The BBU 102 may begin discharging stored energy. The system 100 may transition into the pre-charging state to maintain system stability.

During a BBU discharging and bulk capacitor pre-charging phase (t₂<t<t₂′) as shown in FIG. 3C, the BBU 102 may actively charge the bulk capacitor 105 while also supplying power to the load. The bi-directional DC-DC converter of the BBU 102 may boost the battery voltage such that a portion of the boosted energy charges the bulk capacitor 105 and the rest supplies the load via the 51V and RTN lines. Control logic (not shown in FIG. 3C) may ensure that the bulk capacitor 105 reaches its target voltage (e.g., 400V_{dc}) while the load continues receiving uninterrupted power. The stored energy in the BBU 102 may flow into the bulk capacitor 105 to return its voltage to its fully charged state (e.g., 400V_{dc}). This operation may ensure that, when AC power returns, the bus bar voltage (v_{bus}) is at a level higher than the AC input voltage (v_{ac}) so the re-rush current is limited or prevented because the bulk capacitor 105 is already pre-charged. The pre-charging may occur gradually to avoid sudden surges or disruptions.

During a BBU discharging phase (t₂′<t<t₃) as shown in FIG. 3D, once the pre-charging process is complete and the capacitor voltage reaches the desired level (e.g., 400V_{dc}), the BBU 102 may switch its primary focus to supplying power to the load. The bulk capacitor 105 may maintain its voltage, ensuring no re-charging surge occurs upon AC power resumption.

During a steady-state phase (t>t₃) as shown in FIG. 3E, at time t₃, AC input power is restored, and the system 100 may transition back to steady-state operation. Since the bulk capacitor 105 has been fully recharged, limited or no re-rush current may occur. The PSU 101 may resume normal power conversion and take over supplying power to the load. The BBU 102 may deactivate or return to standby mode.

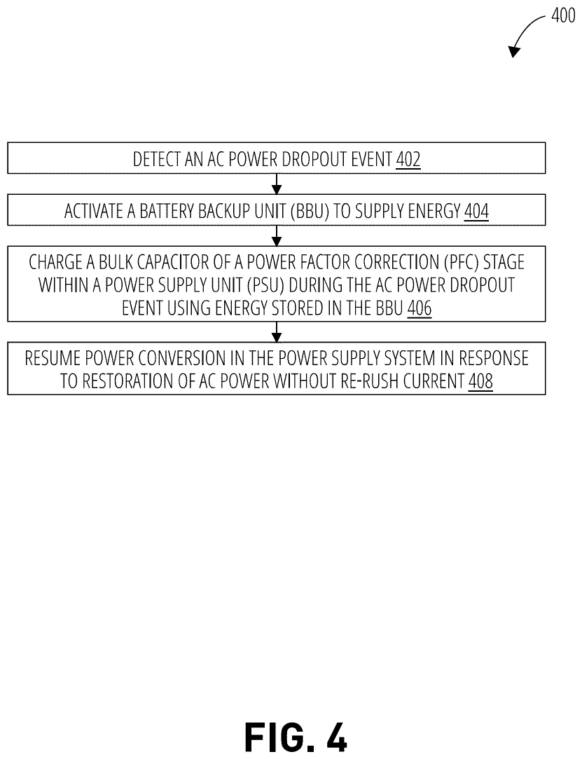

FIG. 4 is a flowchart of a method 400 for preventing re-rush current in a power supply system, according to some aspects of the present disclosure. It is to be appreciated that more or fewer operations than those shown in FIG. 4 may be performed. Further, some of the operations can be performed simultaneously, or in a different order than shown in FIG. 4, as will be understood by a person of ordinary skill in the art. Method 400 can be implemented by systems related to FIGS. 3A-3E and operations caused by a computing device. However, method 400 is not limited to that example aspect.

In operation 402, method 400 detects an AC power dropout event. In operation 404, method 400 activates a battery backup unit (BBU) to supply energy. In operation 406, method 400 charges a bulk capacitor of a power factor correction (PFC) stage within a power supply unit (PSU) during the AC power dropout event using energy stored in the BBU. In operation 408, method 400 resumes power conversion in the power supply system in response to restoration of AC power without re-rush current.

In some examples, the BBU may be configured to simultaneously supply power to a load while charging the bulk capacitor. In some examples, charging the bulk capacitor may occur through a controlled discharge process of the BBU. Method 400 may further include monitoring the voltage of the bulk capacitor to determine when it is fully charged. In response to detecting that the bulk capacitor is fully charged, the BBU may prioritize supplying power to the load.

In some examples, the BBU may be activated in response to the output of the PSU falling below a threshold voltage. The BBU may be turned off when the PSU output exceeds the threshold voltage. Method 400 may further comprise detecting restoration of AC power and transitioning the power supply system to steady-state operation. In one or more examples, power conversion may resume in response to detecting restoration of AC power.

Upon restoration of AC power, a bus voltage may exceed a peak AC input voltage. The bulk capacitor may have a voltage rating of approximately 400 Vdc or 450 Vdc for a 277 Vac input voltage, though other voltage ratings may be used.

Various examples have been disclosed herein, in connection with the above description and the drawings. It will be understood that it would be unduly repetitious to literally describe and illustrate every combination and subcombination of these examples. Accordingly, all examples can be combined in any way or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A method for limiting re-rush current in a power supply system, the method comprising:
detecting an AC power dropout event;
activating a battery backup unit (BBU) to supply energy;
charging a bulk capacitor of a power factor correction (PFC) stage within a power supply unit (PSU) during the AC power dropout event using energy stored in the BBU; and
resuming power conversion in the power supply system in response to restoration of AC power to limit re-rush current.

2. The method of claim 1, wherein the BBU is to simultaneously supply power to a load while charging the bulk capacitor.

3. The method of claim 1, wherein charging the bulk capacitor occurs through a controlled discharge process of the BBU.

4. The method of claim 1, further comprising monitoring the voltage of the bulk capacitor to determine when it is fully charged.

5. The method of claim 4, wherein the BBU prioritizes supplying power to a load in response to the bulk capacitor being fully charged.

6. The method of claim 1, wherein the BBU is activated in response to a PSU output falling below a threshold voltage and is turned off in response to the PSU output exceeding the threshold voltage.

7. The method of claim 1, further comprising detecting restoration of AC power and transitioning the power supply system to steady-state operation.

8. The method of claim 7, wherein power conversion resumes in response to detecting restoration of AC power.

9. The method of claim 1, wherein a bus voltage exceeds a peak AC input voltage when AC power is restored.

10. The method of claim 1, wherein a voltage rating of the bulk capacitor is approximately 400V_{dc} or 450V_{dc} for a 277V_{ac} input voltage.

11. An apparatus for limiting re-rush current in a power supply system, the apparatus comprising:
a power supply unit (PSU) having a power factor correction (PFC) stage with a bulk capacitor;
a battery backup unit (BBU) to store and discharge energy; and
a controller to:
detect an AC power dropout event;
activate the BBU to charge the bulk capacitor during the AC power dropout event; and
resume power conversion in the PSU in response to restoration of AC power to limit re-rush current.

12. The apparatus of claim 11, wherein the BBU is to simultaneously supply power to a load while charging the bulk capacitor.

13. The apparatus of claim 11, wherein the controller is to monitor the voltage of the bulk capacitor to terminate charging when the capacitor is fully charged.

14. The apparatus of claim 11, wherein the PSU and the BBU are connected via a bus line and a return line.

15. The apparatus of claim 11, wherein the BBU comprises a battery pack and a bi-directional DC-DC converter.

16. The apparatus of claim 11, wherein the controller is to detect AC power restoration and transition to a steady-state operating mode.

17. The apparatus of claim 11, wherein a voltage rating of the bulk capacitor is approximately 400V_{dc} or 450V_{dc} for a 277V_{ac} input voltage.

18. The apparatus of claim 11, further comprising a detection module for determining AC power dropout and restoration conditions.

19. The apparatus of claim 11, wherein the controller is to activate the BBU based on a predefined voltage threshold for the bulk capacitor.

20. The apparatus of claim 11, wherein the voltage of the bulk capacitor is to be incrementally increased during a pre-charging state to limit re-rush current.
